(19) United States
(12) Patent Application Publication
(10) Pub. No.: US 2019/0247814 A1
(43) Pub. Date: Aug. 15, 2019

(54) POLYCRYSTALLINE DIAMOND FROM VITREOUS CARBON AND TRANSITION METAL FREE CARBONATE CATALYST AND METHOD OF PRODUCING

(71) Applicant: DIAMOND INNOVATIONS, INC., Worthington, OH (US)

(72) Inventors: Emil T. STOYANOV, Dublin, OH (US); Abds-Sami MALIK, Westerville, OH (US)

(73) Assignee: DIAMOND INNOVATIONS, INC., Worthington, OH (US)

(21) Appl. No.: 16/272,535

(22) Filed: Feb. 11, 2019

Related U.S. Application Data
(60) Provisional application No. 62/629,811, filed on Feb. 13, 2018.

(51) Int. Cl. B01J 3/06; C04B 35/52; C04B 35/645

(52) U.S. Cl. CPC B01J 3/062; C04B 35/52; C04B 35/645; B01J 2203/062; B01J 2203/0685; C04B 2235/407; C04B 2235/5454; C04B 2235/80; C04B 2235/9607; C04B 2235/3213; C04B 2235/442; C04B 2235/427

(57) ABSTRACT

A transition metal catalyst free polycrystalline diamond compact having enhanced thermal stability is disclosed herein. The diamond compact may be attached to a hard metal substrate. The polycrystalline diamond body includes a plurality of diamond grains bonded to adjacent diamond grains by diamond-to-diamond bonds. Sintering of the PCD and the formation of diamond-to-diamond bonding is achieved by transforming graphene treated diamond crystals that are blended with non-metal additives at high pressure and high temperature into a diamond compact that is free of transition metal catalysts. Non-metal additives include vitreous and other non-equilibrium forms of carbon as well as Sr-, K- and Ca-containing carbon sources.

### TECHNICAL FIELD AND INDUSTRIAL APPLICABILITY

The present disclosure relates generally to polycrystalline diamond (PCD) materials that are free of Co, W, Ni, or other metals and are able to withstand the high temperatures associated with cutting, drilling, and mining applications. The material can be made entirely free of metals or can be free of metals on a top layer ranging in thickness from a few to several hundred microns.

As is conventionally known, sintering of diamond particles takes places at elevated temperatures and pressures (HPHT process) in the presence of a catalyst material that promotes formation of diamond-to-diamond bonds. The catalyst material may be embedded in a substrate, for example, a cemented tungsten carbide substrate having cobalt, or blended with the diamond particles. The catalyst material may infiltrate the diamond particles from the substrate. Following the HPHT process, the diamond particles are sintered to one another to form a compact, which may be attached to the substrate.

While the catalyst material promotes formation of the inter-diamond bonds during the HPHT process, some amount of the catalyst metal remains in the sintered diamond compact after the completion of the HPHT process. The presence of metal catalyst may reduce the thermal stability and be detrimental to the mechanical properties of the polycrystalline diamond compact at elevated temperature. This is because some of the diamond grains may undergo a back-conversion to a softer non-diamond form of carbon (for example, graphite or amorphous carbon) due to the frictional heat generated during the rock or metal cutting process. Further, differences in the coefficients of thermal expansion (CTE) of the materials present in the sintered compact may induce stress in the diamond compact causing microcracks in the diamond compact. Back-conversion of diamond and the stresses induced by the mismatch of thermal expansion of the materials may contribute to a decrease in the toughness, abrasion resistance, and/or thermal stability of the PCD cutting elements during operation.

Therefore, as can be seen, polycrystalline diamond compacts that are free of metal catalyst, may provide improved abrasion resistance and possess increased thermal stability.

### SUMMARY

In one embodiment, a polycrystalline diamond compact may include a plurality of diamond particles bonded to adjacent diamond particles by diamond-to-diamond bonds forming a continuous diamond matrix and a plurality of interstitial regions positioned between adjacent diamond particles and forming a continuous interstitial matrix. At least a portion of the continuous interstitial matrix may be substantially free from any metals and only carbon is detectable in the polycrystalline diamond compact.

In another embodiment, a polycrystalline diamond compact may include a plurality of diamond particles bonded to adjacent diamond particles by diamond-to-diamond bonds forming a continuous diamond matrix and a plurality of interstitial regions positioned between adjacent diamond particles and forming a continuous interstitial matrix The polycrystalline diamond compact may include a plurality of diamond particles bonded to adjacent diamond particles by diamond-to-diamond bonds and a plurality of interstitial regions positioned between adjacent diamond particles. At least a portion of the plurality of interstitial regions may contain newly formed diamond crystals, with sizes from about 50 nm to about a few hundred microns, and also include strontium, calcium or potassium bearing carbon containing crystalline phases that are present in an amount of at least about 0.4 vol %.

### BRIEF DESCRIPTION OF THE DRAWINGS

The following detailed description can be read in connection with the accompanying drawings in which like numerals designate like elements:

FIG. 1 is a Raman spectrum of vitreous glassy carbon.

FIG. 2 is a SEM image of vitreous glassy carbon particles with spherical shape.

FIG. 3 is a SEM image of vitreous carbon particles with irregular shape.

FIG. 4 is a method of making a polycrystalline diamond compact in an exemplary embodiment.

FIG. 5 is an SEM image at 5,000× magnification, of a diamond compact.

FIG. 6 is an SEM image at 20,000× magnification, of a diamond compact and its corresponding EDS spectrum showing elemental analysis.

FIG. 7 is an XRD pattern of a sintered diamond compact.

FIG. 8 is an XRD pattern of sintered a diamond compact.

FIG. 9 is a SEM image of sintered diamond crystals as a result of the HPHT process.

FIG. 10 is an EDS spectrum showing elemental analysis on a catalyst material trapped in the interstitial space in between sintered diamond crystals.

FIG. 11 is an XRD pattern of sintered diamond compact.

FIG. 12 is a Raman spectrum of diamond feed.

FIG. 13 is an SEM image at 50,000× magnification, of diamond nano-crystals.

FIG. 14 is Raman spectra of diamond nano-crystals formed in the interstitial space in between larger diamond crystals.

FIG. 15 is normalized abrasion resistance (NAR) results of sintered diamond compacts.

### DETAILED DESCRIPTION

As used herein, the term “about” means plus or minus 10% of the numerical value of the number with which it is being used. Therefore, about 50% means in the range of 45%-55%. When the term, “substantially free”, is used referring to catalyst in interstices, interstitial matrix, or in a volume of polycrystalline element body, such as polycrystalline diamond, it should be understood that many, if not all, of the surfaces of the adjacent diamond crystals may still have a coating of the catalyst. Likewise, when the term “substantially free” is used referring to catalyst on the surfaces of the diamond crystals, there may still be catalyst present in the adjacent interstices.

As used herein, the term “graphene treated diamond” refers to a form of diamond particle that is treated with graphitic carbon, in which the graphitic carbon atoms are arranged in a 2-dimensional hexagonal lattice, that can be as thin as one atomic layer (<1 nm). These layers can also exist as multiple stacked sheets, forming bi-layer or multi-layer graphene. The graphene treatment provides diamond particles in intimate contact with single layer, bi-layer, or multi-layer graphene.

As used herein, the term “vitreous carbon (VC)” refers to vitreous and other non-equilibrium forms of carbon, representing state of frozen-in disorder, increased thermodynamic potential and elevated chemical affinity. Additionally, the structure of the materials may be composed of a mix of sp²- and sp³-bonded carbon atoms. The structure may also be composed of only sp³-hybridizes carbon atoms.

As used herein, the term “continuous diamond matrix” refers to diamond particles sintered together to form an interconnected plurality of diamond particles where each diamond particle is connected to at least one adjacent diamond particle.

As used herein, the term “continuous interstitial matrix” refers to the space that is formed in between the sintered diamond particles forming the “continuous diamond matrix”, as defined in paragraph [0026]. Therefore, the “continuous interstitial matrix” is complementary to the “continuous diamond matrix.”

The term “superabrasive compact”, as used herein, refers to a sintered product made using super abrasive particles, such as diamond particles. The compact may include a support, such as a tungsten carbide support, or may not include a support. The “superabrasive compact” is a broad term, which may include cutting element, cutters, or polycrystalline diamond inserts.

“Full width at half maximum” or “FWHM” as used herein is a measure of the peak width on a graph. For example, on an X-ray diffractogram, the height of a peak is measured from the baseline to the highest point of the peak. At half of this height (half maximum), the width of the peak is measured. This is a measure of the dispersion of a peak. This can be done for other types of data, such as a Raman spectrum.

The term “feed” or “diamond feed”, as used herein, refers to any type of diamond particles, used as a starting material in further synthesis of PCD compacts.

“Thermally stable polycrystalline diamond” as used herein is understood to refer to a polycrystalline diamond compact that includes a volume or region that is substantially free from transition metal catalysts such as, but not limited to Co, Ni and Fe and is not adversely impacted at elevated temperatures as discussed above.

Thermal stability of sintered polycrystalline diamond compacts was evaluated by performing an interrupted milling test. In this test, polycrystalline diamond compacts are processed into discs and used to machine granite without the use of coolant, resulting in high heat generation in the material. The materials were ranked based on the number of passes across a 1641 long rock before the disc fails. Failure is determined as the material wearing through the sintered compact layer and into a hard metal substrate, at which point, the heat generated rapidly increases. Conventionally sintered diamond compacts that contain trapped metal catalysts run about 0.5 to about 1 pass before failure.

The abrasion resistance of sintered polycrystalline diamond compacts was evaluated by shooting a sample with an air jet containing abrasive particles, namely diamond. The diamond particles from the air jet interact with the sintered compact, causing loss of material, which can be measured by weighing on an analytical balance. The amount of weight lost was used to evaluate the degree of sintering in the thermally stable material.

Raman spectroscopy was performed on a Horiba LabRAM HR instrument using 785 nm and 532 nm laser excitation with a 600 grating and an aperture size between 100 μm and 1000 μm. A 100× objective lens was used with a spot size of about 1 μm.

Scanning electron microscopy (SEM) and elemental analysis (EDS) were performed on a Jeol JSM-7200F SEM with 5-15 kV accelerating voltage. EDS was done with an Oxford XMAX with solid state detector.

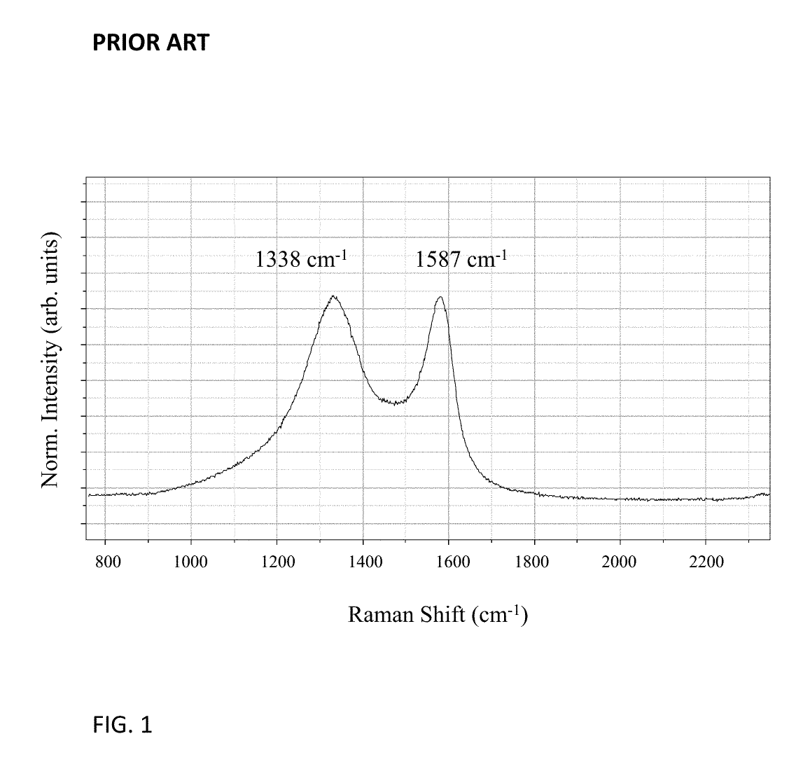

FIG. 1 is a Raman spectrum of vitreous carbon, which shows that both graphite-type sp²-hybridized carbon atoms and diamond-type sp³-hybridized atoms are present in the material. The vitreous state suggests that the material has an increased thermodynamic potential, which can be harnessed to drive a desired chemical reaction. In this case, the desired chemical reaction is diamond formation.

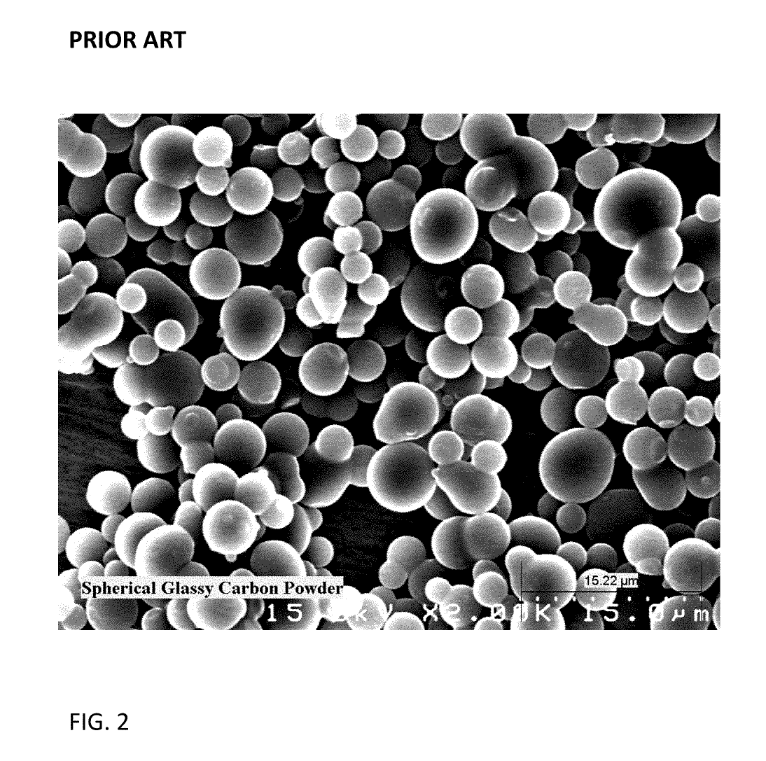

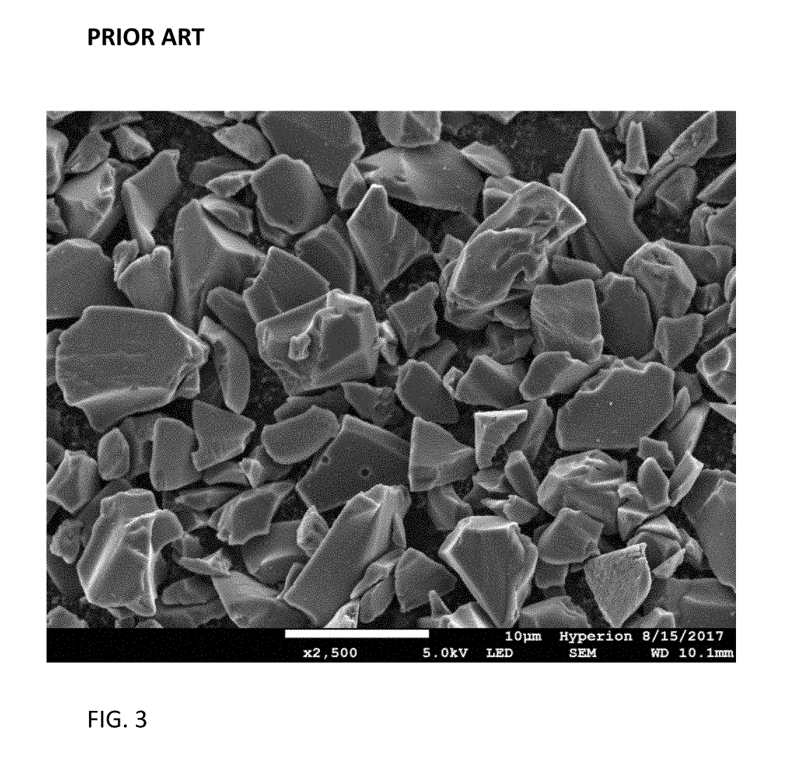

Furthermore, “vitreous carbon” sources, as shown in FIG. 2, may include spherical particles with sizes from about 0.4 μm to about 12 μm, where the density of the material is about 1.45 g/cm³. “Vitreous carbon” sources may also include irregularly shaped particles, as shown in FIG. 3, with dimensions of about 0.4 μm to about 12 μm, where the density of the material is about 1.45 g/cm³.

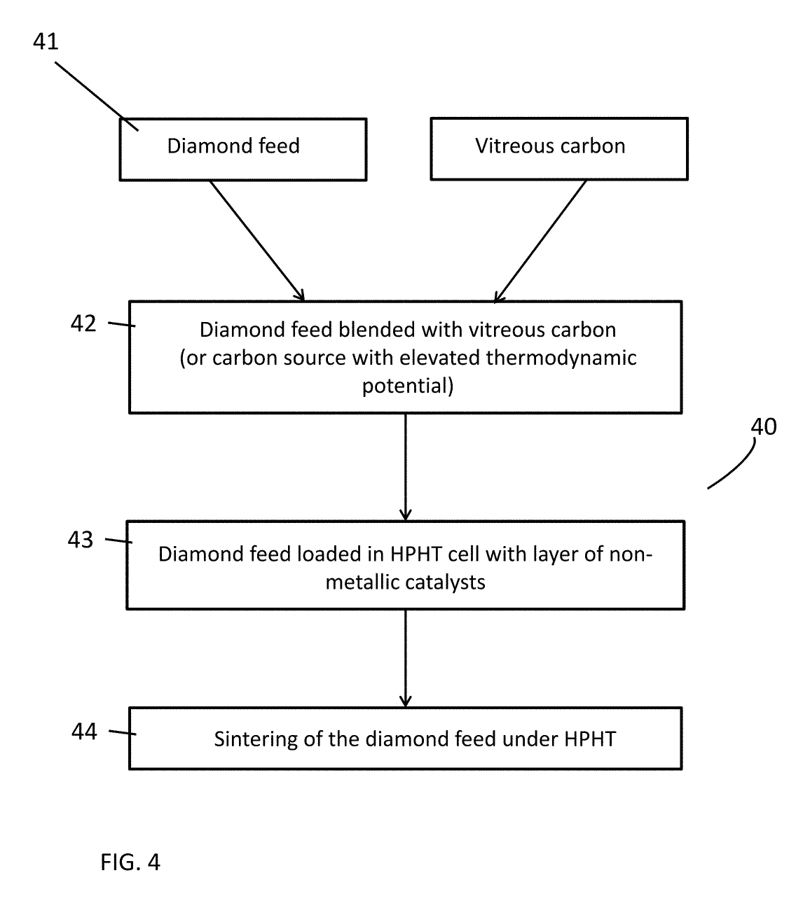

As shown in FIG. 4, a method 40 of making a thermally stable polycrystalline diamond compact may comprise of step 41 of selecting diamond feed and vitreous carbon. The diamond feed may comprise diamond particles with a monomodal particle size distribution or may be a blend of diamond particles with more than one size. The shape of the vitreous carbon particles may be either rounded (spherical or oval) or rectangular. The materials from step 41 are further blended in step 42 to form a uniform mixture of diamond particles and vitreous carbon particles. The so prepared blend from step 42 is then loaded with non-metallic catalysts in a high pressure assembly in step 43. More specifically, the step 43 may further include steps of positioning a diamond blend in between a substrate and non-metal catalyst. Sintering of the diamond feed under HPHT into thermally stable polycrystalline diamond compact is done in step 44. The step 44 may further include a step of sintering the diamond blend into a polycrystalline diamond compact and securing it to a substrate.

Exemplary embodiments disclose a thermally stable material and a method of making the said material. In an exemplary embodiment, a blend of graphene treated diamond and a non-equilibrium carbon source may be loaded into a high pressure cup assembly together with Sr-, Ca- and K-bearing catalysts as well as Cu and/or Sn. The Sr-, Ca- and K-bearing catalysts may comprise carbonates, bicarbonates and oxalates of the said elements, for example. The cup assembly may also contain a tungsten carbide substrate. This cup assembly may be then loaded into a HPHT cell and pressed at pressures up to 90 kBar, temperatures up to 2000° C. (HPHT process) and sintered for up to 60 minutes.

In one embodiment, a hard polycrystalline diamond composite compact is fabricated by forming a mixture of graphene treated diamond powder with a vitreous carbon source plus Cu and/or Sn, and the mixture is subjected to HPHT process, thereby forming a dense polycrystalline compact where adjacent diamond particles are bound together by newly formed diamond-to-diamond bonding.

For example, the material shows the presence of only sp³-bonded carbon atoms as measured by Raman spectroscopy. Furthermore, the compact is substantially free from any metal catalysts.

In another embodiment, a polycrystalline diamond compact may be formed by placing graphene treated diamond feed and Cu and/or Sn in contact with Sr-, Ca- and K-bearing carbon catalysts. In this embodiment, the Sr, Ca and/or K carbon sources may act as catalyst materials and infiltrate into the graphene treated diamond feed during the HPHT process promoting the formation of new diamond-to-diamond bonding.

For example, the polycrystalline diamond compact may exhibit a gradient in the concentrations of the catalyst materials through the volume of the compact. The gradient may be from about 1.5 wt % Sr, Ca or K in the top 100 μm to 0.02 wt % Sr, Ca or K to about a depth of 2000 μm, nearing the substrate.

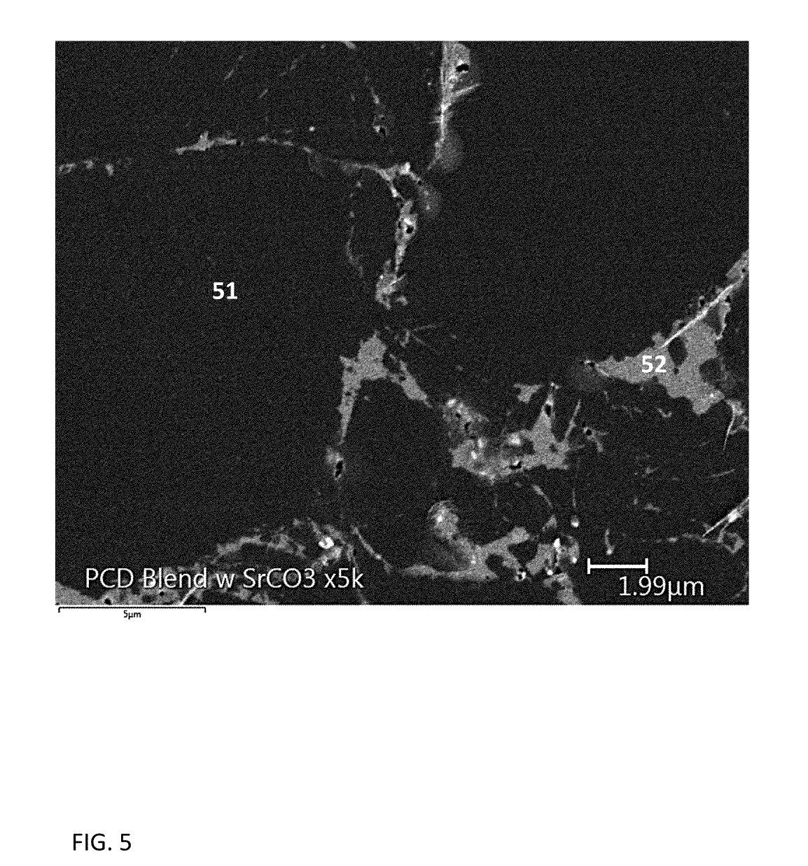

FIG. 5 is a SEM image of sintered diamond particles as a result of the HPHT process. It shows diamond particles 51 (dark grey) with numerous newly formed diamond-to-diamond contact points resulting from the introduction of a Sr-bearing catalyst 52 (light grey).

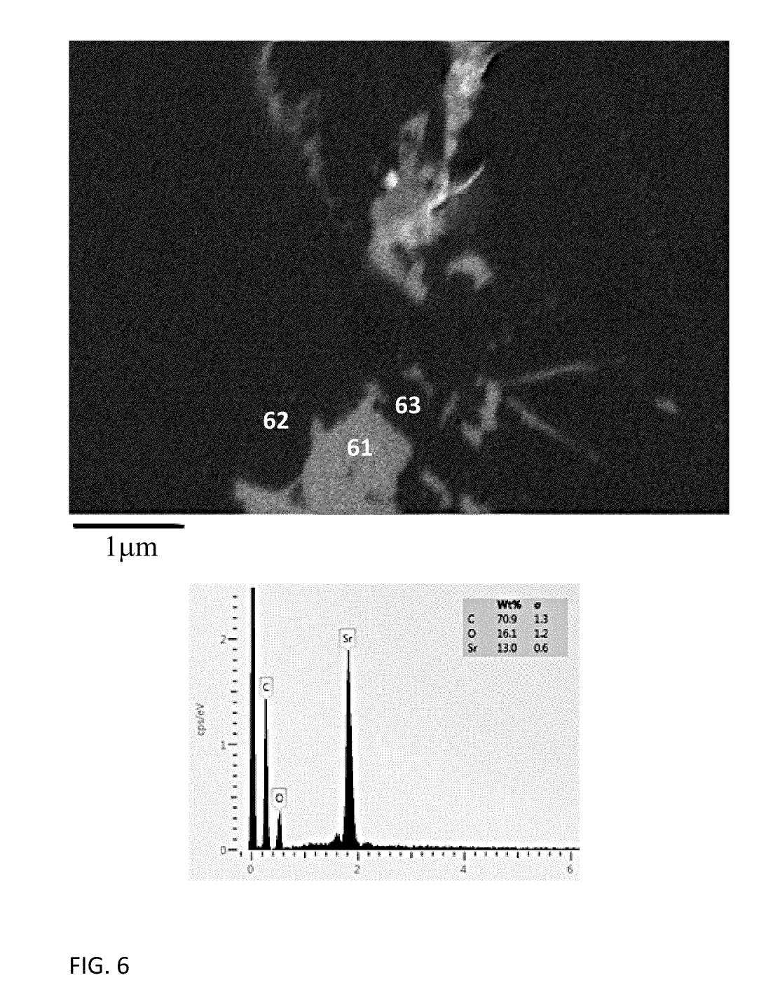

FIG. 6 shows an EDS spectrum measured on a catalyst material trapped in the interstitial space 61 in between sintered diamond particles 62 and 63. The only elements detected in the interstitial space are Sr, O and C.

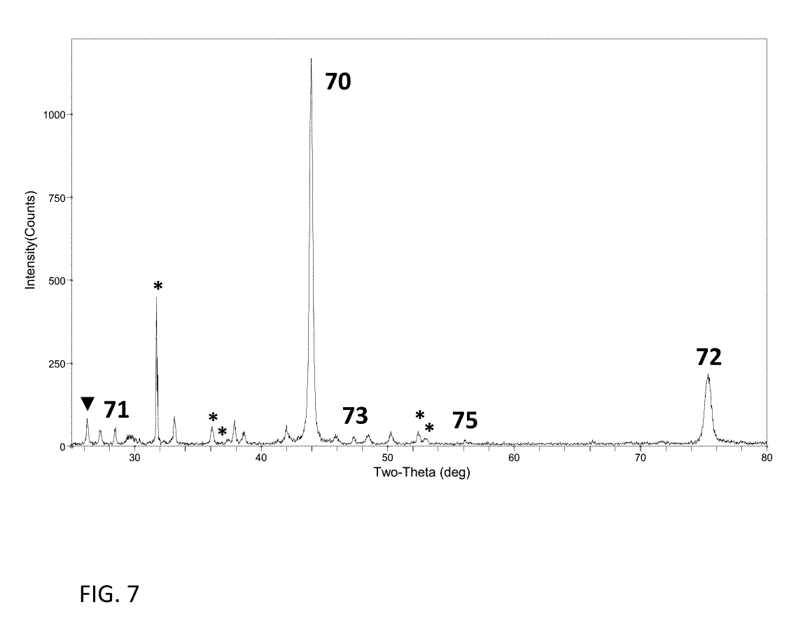

Furthermore, for example, the polycrystalline diamond compact may contain some amount of the Sr-bearing catalyst left after the HPHT process. The amount of catalyst may be from about 0.5 vol % SrO to about 8.0 vol % SrO. Additionally, the SrO is present as a high-pressure phase that exhibits tetragonal crystal structure with cell parameter a of about 4.91 Å and cell parameter c of about 4.95 Å. It is to be understood that at ambient pressure and temperature the crystal structure of the SrO is cubic (NaCl-type). FIG. 7 shows an XRD pattern of a superabrasive thermally stable diamond compact containing about 1.5 vol % of SrO. The drop lines 70 and 72 indicate the diamond XRD peaks, peaks 71, 73, and 75 indicate the position of the Si internal standard used to align the diffraction pattern, the triangles (▾) show the XRD peak of graphite and the asterisks (*) indicate the XRD peaks of SrO.

Furthermore, for example, the polycrystalline diamond compact may contain certain amount of the K-bearing catalyst left after the HPHT process. The amount of catalyst may be from about 0.5 vol % KHCO₃ to about 8.0 vol % KHCO₃.

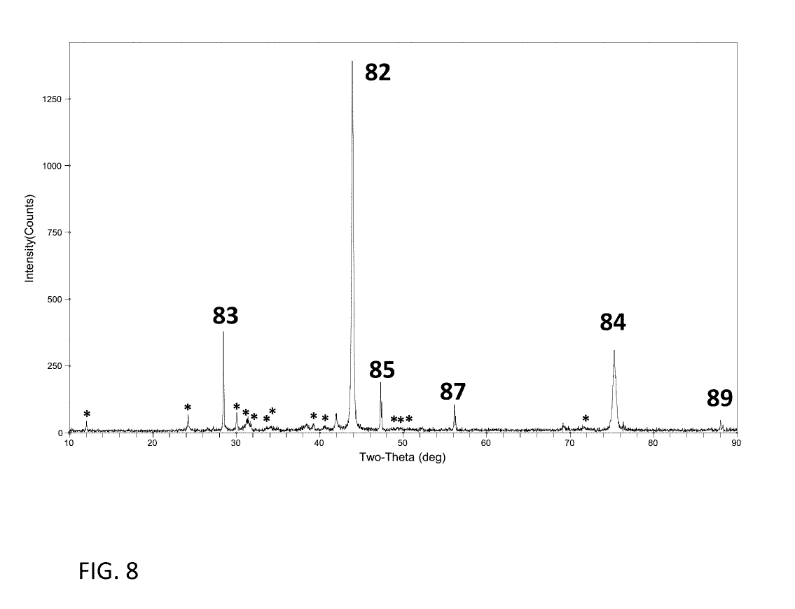

FIG. 8 shows an XRD pattern of a superabrasive thermally stable diamond compact containing 8 vol % of KHCO₃. Diffraction peaks 82 and 84 indicate the diamond XRD peaks, peaks 83, 85, 87 and 89 indicate the position of the Si internal standard used to align the diffraction pattern and the asterisks (*) indicate the XRD peaks of KHCO₃.

In yet another embodiment, a polycrystalline diamond compact is formed by placing a blend of vitreous carbon particles with graphene treated diamond feed and Cu and/or Sn in contact with Sr-, Ca- and K-bearing carbon catalysts. In this embodiment, the vitreous carbon particles and the Sr, Ca and/or K carbon sources may act as catalyst materials during the HPHT process and may promote the formation of new diamond-to-diamond bonding.

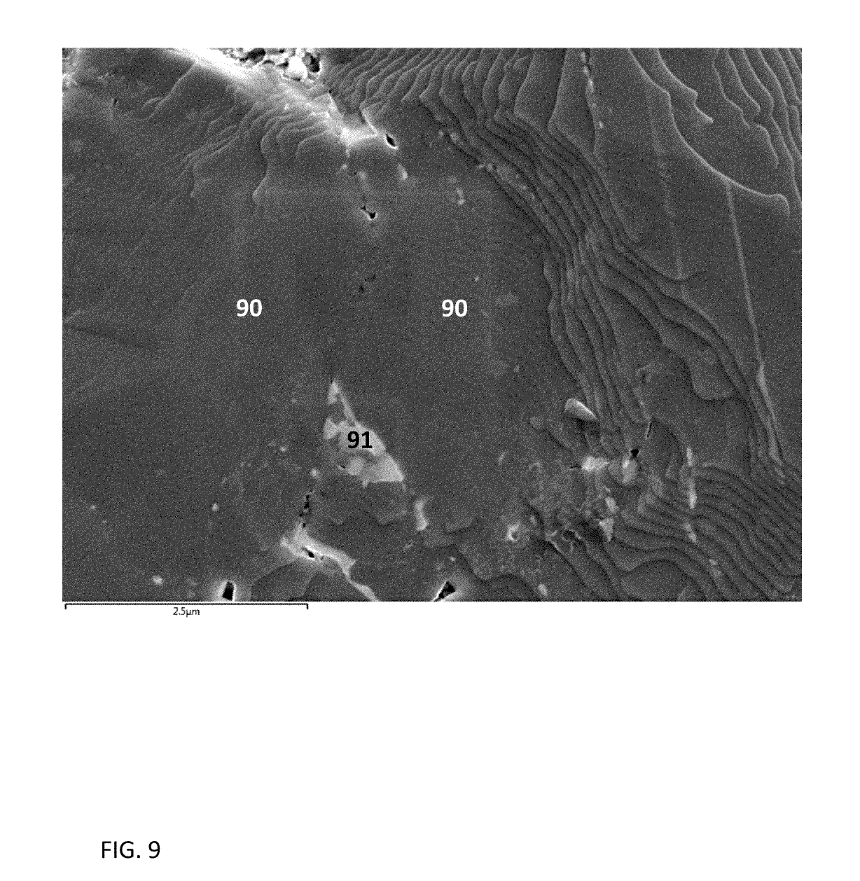

FIG. 9 is a SEM image of sintered diamond particles after the HPHT process. The material shows numerous newly formed diamond-to-diamond contact points across the interfaces of diamond particles 90 (dark grey). The sintering may be a result from the reaction between Sr-bearing catalyst 91 (light grey) and graphene treated diamond blended with vitreous carbon.

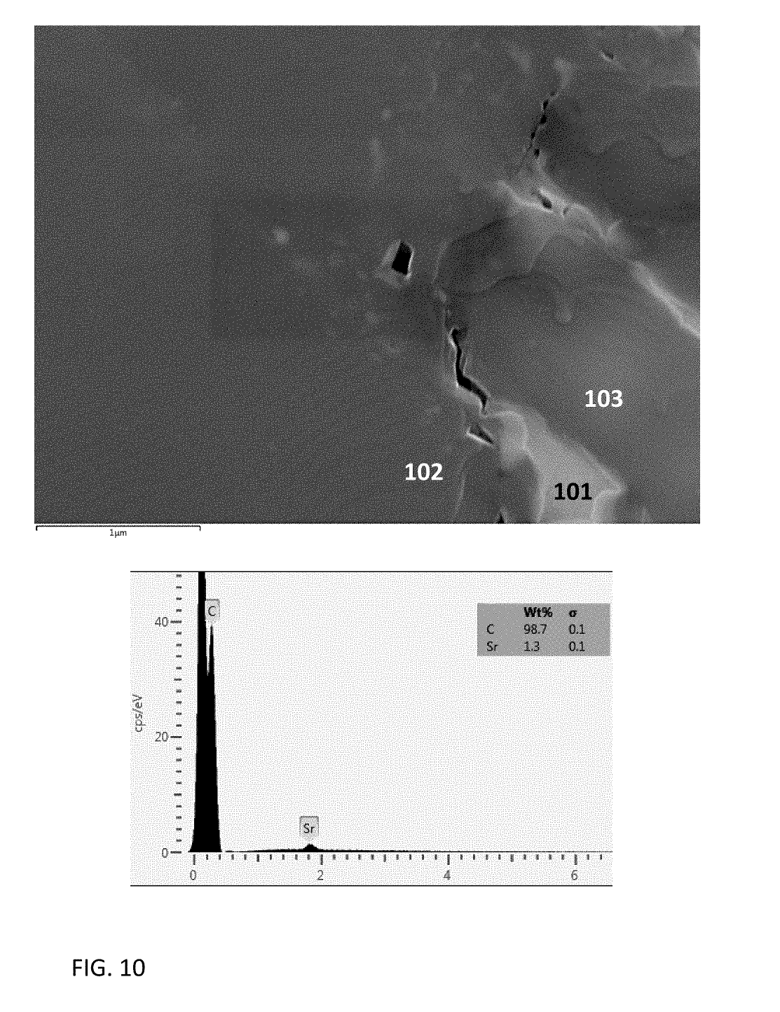

FIG. 10 shows an EDS spectrum measured on a catalyst material trapped in the interstitial space 101 in between sintered diamond particles 102 and 103. The only elements detected in the interstitial space are Sr, O and C.

Furthermore, for example, the polycrystalline diamond compact may contain some amount of the Sr-bearing catalyst left after the HPHT process. The amount of catalyst may be from about 0.5 vol % SrCO₃ to about 8.0 vol % SrCO₃.

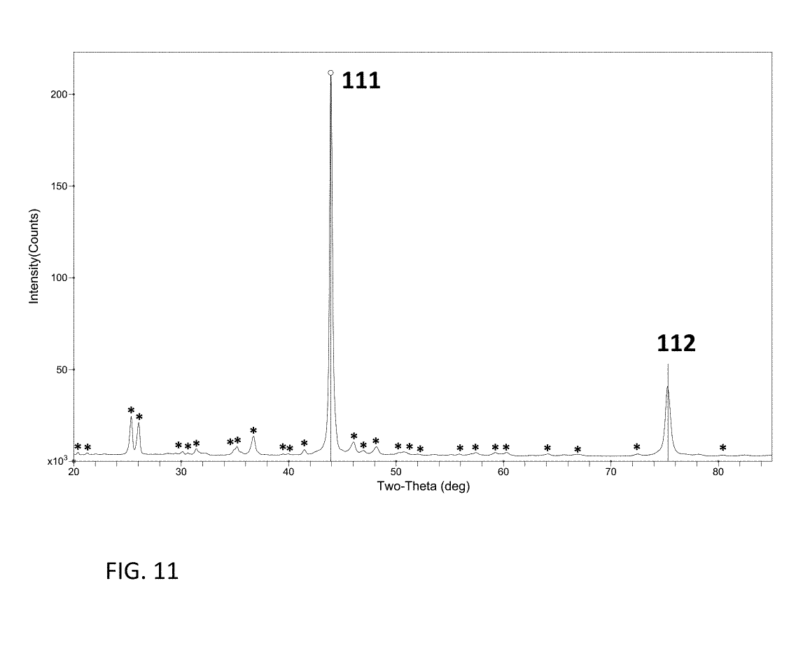

FIG. 11 shows an XRD pattern of a thermally stable diamond compact containing 3.0 vol % of SrCO₃. The drop lines 111 and 112 indicate the diamond XRD peaks, and the asterisks (*) indicate the XRD peaks of SrCO₃.

Furthermore, for example, the polycrystalline diamond compact formed by placing a blend of vitreous carbon particles with graphene treated diamond feed and SrCO₃ may have amounts of Cu and Sn as listed in Table 1.

TABLE 1

| | Cu, wt % | Sn, wt % |
|---|---|---|
| Sample 1 | 0.088 | 0.083 |
| Sample 2 | 0.011 | 0.001 |
| Sample 3 | 0.030 | 0.014 |
| Sample 4 | 0.031 | 0.021 |
| Sample 5 | 0.039 | 0.044 |
| Sample 6 | 0.030 | 0.019 |
| Sample 7 | 0.034 | 0.014 |
| Sample 8 | 0.029 | 0.016 |
| Sample 9 | 0.033 | 0.040 |

Furthermore, for example, the polycrystalline diamond compact may have an improved thermal stability as measured by the method described in paragraph [0032]. Samples of the sintered polycrystalline compact ran about 5-6 passes before failure, showing a significant improvement in the thermal stability over conventionally sintered diamond compacts. Furthermore, for example, the polycrystalline diamond compact may have characteristic features when measured by Raman spectroscopy. Raman spectra can be used as a ‘fingerprint’ of graphite, diamond and other carbon based materials. They can provide a wealth of information about the crystalline structure, atomic interactions, etc. in diamond.

Additionally, the full width at half maximum (FWHM) of the diamond peak may be associated with the internal stresses developed in the diamond during the formation and growth of new crystals. Thus, it may be used to distinguish newly formed diamond from the starting diamond feed used to make the polycrystalline compact. By utilizing spatially resolved Raman techniques, such as mapping, the distribution of the stresses across a sample can also be characterized.

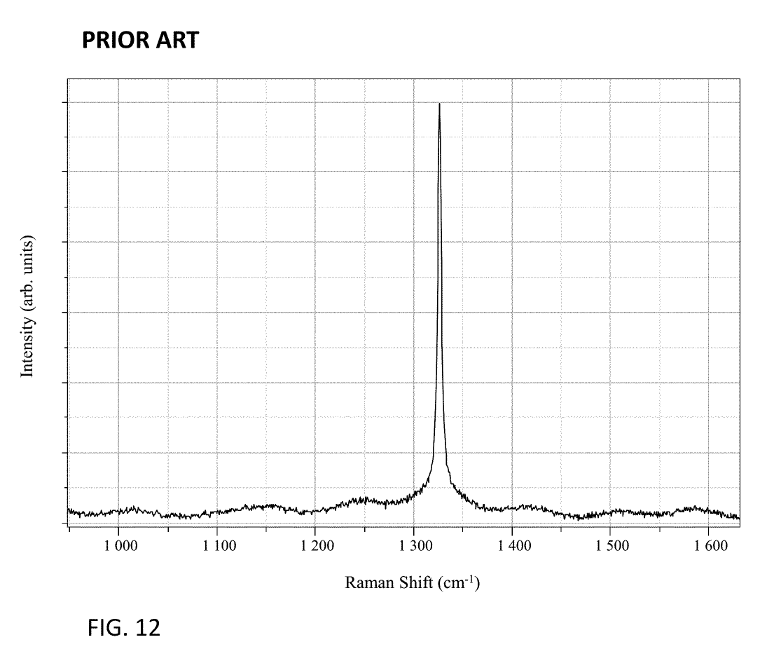

FIG. 12 shows a Raman spectrum of diamond feed used for making sintered polycrystalline diamond materials. It shows a single sharp peak at about 1328 cm⁻¹ with a FWHM of about 5.3 cm⁻¹.

Furthermore, for example, the sintered compact may contain newly formed nano-sized regions and crystals of diamond with characteristically distinct Raman spectroscopy features from about 1025 cm⁻¹ to about 1250 cm⁻¹. It is to be understood that conventionally synthesized and natural diamond crystals have a single sharp peak located at about 1328 cm⁻¹. The diamond nano-crystals may have sizes from about 50 nm to about 500 nm.

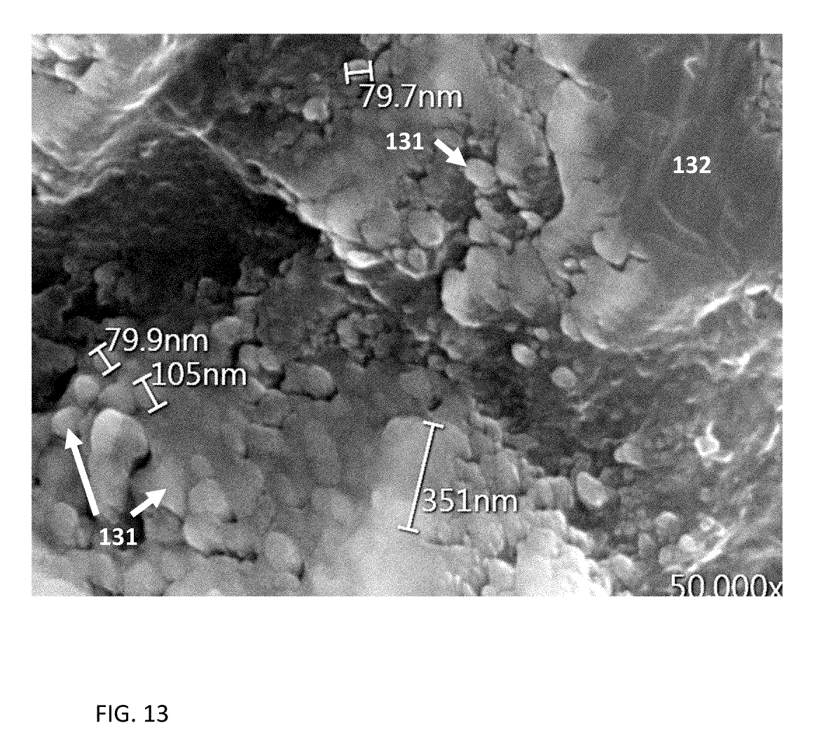

FIG. 13 is a SEM image of diamond nano-crystals 131 distributed throughout the interstitial space between larger diamond particles as well as sintered onto larger diamond crystals 132.

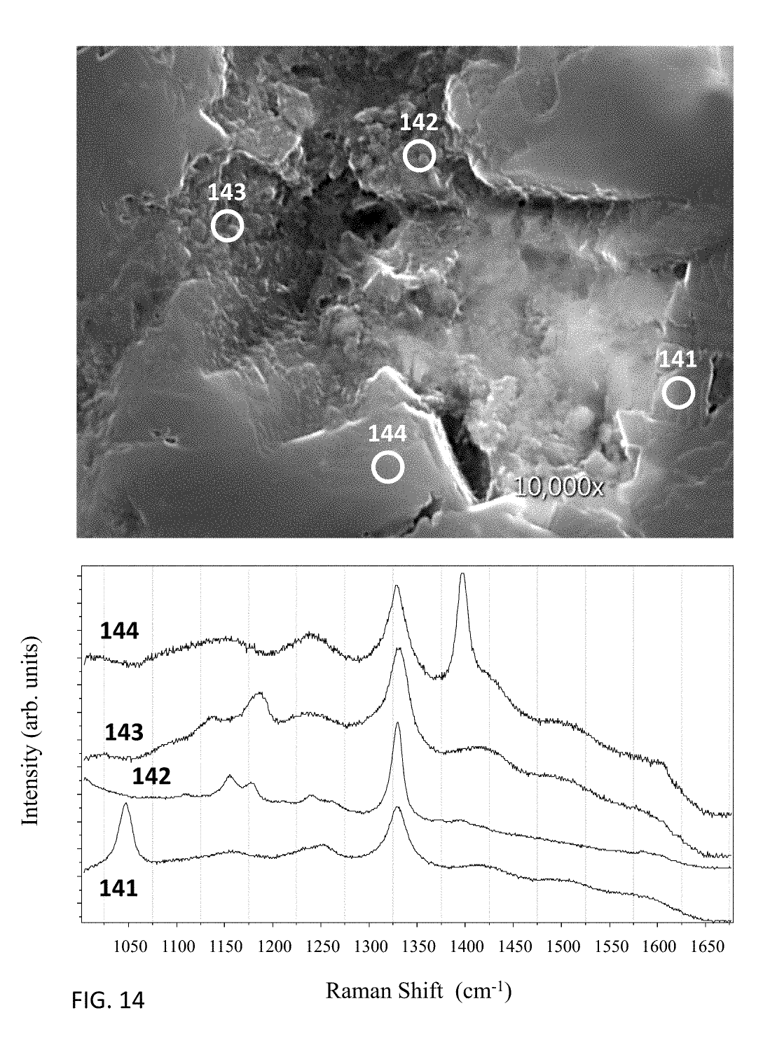

FIG. 14 shows distinctive Raman spectra measured on multiple locations across an interstitial area covered with diamond nano-crystals. In addition to the extra spectral features observed in the range from about 1025 cm⁻¹ to about 1250 cm⁻¹, the Raman spectra of the nano-diamonds have broader main 1328 cm⁻¹ peaks, with FWHM values from about 10 cm⁻¹ to about 30 cm⁻¹. This broadening of the Raman peaks may be due to various degrees of residual stress remaining in the newly formed diamond nanocrystal lattices. The lack of peaks in the range of 1550-1600 cm⁻¹ indicates that graphite and/or graphene is not detected in the sintered compact material.

Furthermore, for example, the broadening of the Raman signal originating from the newly formed diamond in the sintered compact may be in the range of about 7% for peaks with FWHM in the range of 10-15 cm⁻¹, about 51% for peaks with FWHM in the range of 15-20 cm⁻¹, about 30% for peaks with FWHM in the range of 20-25 cm⁻¹, about 11% for peaks with FWHM in the range of 25-30 cm⁻¹, and about 1% for peaks with FWHM in the range of 30-35 cm⁻¹.

Furthermore, for example, the sintered compact may have an abrasion resistance similar or better than conventionally sintered diamond compact that contains trapped metal catalyst, as measured by the method described in paragraph [0033].

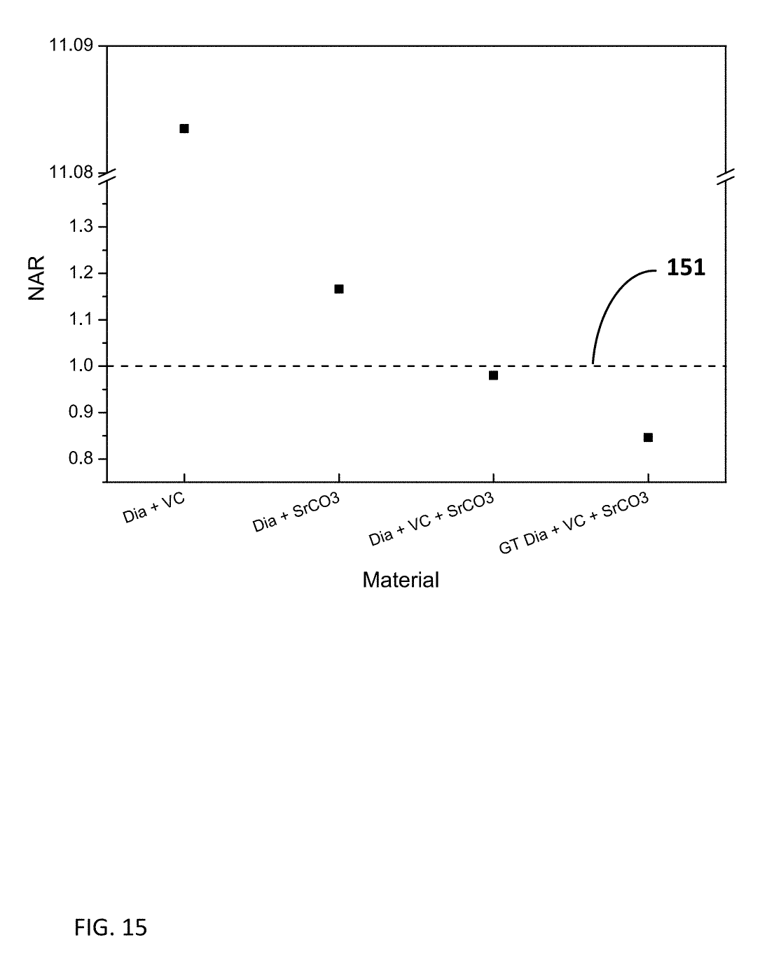

FIG. 15 shows the normalized abrasion resistance (NAR) for using particular embodiments. The data is normalized to the abrasion resistance of a conventionally sintered diamond compact that contains trapped metal catalyst (horizontal line 151 located at 1.0). The figure shows the improvement in the abrasion resistance of the sintered compacts when they are produced by combining either diamond (Dia) or graphene treated diamond (GT Dia) with vitreous carbon (VC) and strontium carbonate (SrCO₃). When only one of the sintering aids is used (either VC or SrCO₃), the abrasion resistance of the resulting compacts is up to about 11× worse than that of the conventionally sintered diamond compact. But when used in conjunction, the abrasion resistance is improved greatly.

What is claimed is:

1. A polycrystalline diamond compact, comprising:
interstitial nanocrystalline diamond; and
at least one of calcium carbonate, strontium carbonate, strontium oxide and potassium bicarbonate.

2. The polycrystalline diamond compact of claim 1, wherein the nanocrystalline diamond has a diameter of 50 nm to 500 nm.

3. The polycrystalline diamond compact of claim 2, wherein the nanocrystalline diamond exhibits Raman spectra comprising broad peaks at 1328 cm⁻¹.

4. The polycrystalline diamond compact of claim 2, wherein the nanocrystalline diamond exhibits Raman spectra comprising broad peaks in the range of from 1025 cm⁻¹ to 1250 cm⁻¹.

5. The polycrystalline diamond compact of claim 1, further comprising copper and/or tin.

6. The polycrystalline diamond compact of claim 1, wherein carbonate comprises 0.5% volume to 8.0% volume.

7. The polycrystalline diamond compact of claim 1, wherein the oxide comprises 0.5 to 8.0% volume.

8. The polycrystalline diamond compact of claim 1, wherein the bicarbonate comprises 0.5 to 8.0% volume.

9. The polycrystalline diamond compact of claim 1, wherein the thermal stability ranges from 3.0 passes to 6.0 passes.

10. The polycrystalline diamond compact of claim 1, wherein the abrasion resistance is up to 30% better than standard conventional diamond compact.

11. A polycrystalline diamond compact, comprising:
interstitial nanocrystalline diamond;
at least one of calcium carbonate, strontium carbonate, strontium oxide and potassium bicarbonate; and
gradients which contain 1.5 wt % Sr, Ca or K in the top 100 μm of depth and contain 0.02 wt % Sr, Ca, or K to a depth of 2000 μm.

12. The polycrystalline diamond compact of claim 11 which is substantially free of cobalt.

13. A method of producing a polycrystalline diamond compact substantially free of cobalt, comprising the steps of:
selecting a diamond feed;
blending the diamond feed with at least one of a vitreous carbon and a carbon source with elevated thermodynamic potential in order to create a blended diamond feed;
loading the blended diamond feed into an HPHT cell along with a layer of non-metallic catalysts to create a blended diamond feed cell; and
sintering the blended diamond feed cell into a polycrystalline diamond compact.

14. The method of claim 13, wherein the non-metallic catalyst comprises at least one of carbonates, bicarbonates are of either Strontium (Sr), Calcium (Ca), and Potassium (K).

15. The method of claim 13, wherein the metallic catalyst comprises at least one of Copper or Tin.

16. The method of claim 13, wherein the HPHT cell is pressed at up to 90 kBar and up to 2000 Celsius.

17. The method of claim 13, wherein the compact is formed by placing graphene and at least one of copper and tin in contact with Sr, Ca and K non-metallic catalysts.

18. The method of claim 16, wherein the cell is pressed at up to 75 kBar and up to 1800 Celsius.

19. The method of claim 13, further comprising glassy carbon with particle sizes between 100 nm and 20 microns.

20. The method of claim 13, further comprising glassy carbon particles with spherical and rectangular shapes.
